(19) United States
(12) Patent Application Publication
(10) Pub. No.: US 2025/0209712 A1
(43) Pub. Date: Jun. 26, 2025

(54) METHOD OF GENERATING FULLBODY ANIMATABLE PERSON AVATAR FROM SINGLE IMAGE OF PERSON, COMPUTING DEVICE AND COMPUTER-READABLE MEDIUM IMPLEMENTING THE SAME

(71) Applicant: SAMSUNG ELECTRONICS CO., LTD., Suwon-si (KR)

(72) Inventors: David Viacheslavovich SVITOV, Moscow (RU); Dmitrii Iurevich GUDKOV, Moscow (RU); Renat Maratovich BASHIROV, Moscow (RU); Victor Sergeevich LEMPITSKY, Moscow (RU)

(73) Assignee: SAMSUNG ELECTRONICS CO., LTD., Suwon-si (KR)

(21) Appl. No.: 19/076,378

(22) Filed: Mar. 11, 2025

Related U.S. Application Data
(63) Continuation of application No. PCT/IB2023/059427, filed on Sep. 25, 2023.

(30) Foreign Application Priority Data
Nov. 2, 2022 (RU) 2022128498
Mar. 29, 2023 (RU) 2023107624

(51) Int. Cl. G06T 13/40; G06T 3/4046; G06T 5/60; G06T 5/70; G06T 5/77; G06T 15/04; G06T 17/20

(52) U.S. Cl. CPC G06T 13/40; G06T 3/4046; G06T 5/60; G06T 5/70; G06T 5/77; G06T 15/04; G06T 17/20; G06T 2207/20081; G06T 2207/20084

(57) ABSTRACT

A computer-implemented method of generating fullbody animatable avatar of a person from a single image of the person includes: obtaining an image of a person body and a parametric body model defined by pose parameters and shape parameters of the person body in the image, and by camera parameters used when capturing the image; defining, based on the parametric body model, a texturing function including a mapping between each pixel corresponding to a part of the person body shown in the image and corresponding texture coordinates in a texture space, and corresponding texture coordinates in the texture space for a part of the person body not shown in the image; sampling RGB texture of the person body based on the mapping and obtaining a map of sampled pixels.

### CROSS-REFERENCE TO RELATED APPLICATION(S)

This application is a continuation application of International Application No. PCT/IB2023/059427, filed on Sep. 25, 2023, which claims priority to Russian Patent Application No. 2023107624, filed on Mar. 29, 2023 and Russian Patent Application No. 2022128498 filed on Nov. 2, 2022, in the Russian Federal Service for Intellectual Property, the disclosures of which are incorporated by reference herein in their entireties.

### BACKGROUND

### 1. Field

This disclosure relates to the field of Artificial Intelligence (AI)-based image synthesis and processing and, more particularly, to a computer-implemented method of generating fullbody animatable clothed avatar of a person from a single image of the person, and to a computing device and a computer-readable medium implementing said method.

### 2. Description of Related Art

The use of fullbody avatars in the virtual and augmented reality applications are one of the drivers behind the recent surge of interest in fullbody photorealistic avatars. Apart from the realism and fidelity of avatars, the ease of acquisition of new personalized avatars is of paramount importance. Towards this end, several related works propose methods to restore 3D textured model of a human from a single image but such models require additional efforts to produce rigging for animation. The use of additional rigging methods significantly complicates the process of obtaining an avatar and often restricts the poses that can be handled. At the same time, some of the recent methods use textured parametric models of human body while applying inpainting in the texture space. Current texture-based methods, however, lack photorealism and rendering quality.

An alternative to using classical RGB textures directly is to use deferred neural rendering. Such approaches make it possible to create human avatars controlled by the parametric model. The resulting avatars are more photo-realistic and easier to animate. However, existing approaches require a video sequence to create an avatar. The StylePeople system, which is also based on deferred neural rendering and parametric model, provides an opportunity to create avatars from single images, however the quality of rendering for unobserved body parts is low.

Many avatar systems are based on parametric human body models, of which the most popular are the SMPL body model as well as the SMPL-X model which augments SMPL with facial expressions and hand articulations. Such models represent human body without garments or hair. Approaches based on deferred neural rendering (DNR), or neural radiance fields (NeRF) can be used to add clothing and perform photo-realistic rendering. DNR uses a multi-channel trainable neural texture and a renderer convolutional network to render the resulting avatars in a realistic way. It makes it easier to animate the resulting avatar. NeRF uses sampling along a ray in implicit space for rendering and allows one to extract accurate and consistent geometry.

One-shot avatar approaches reconstruct human body avatars from a single image. Early works achieved this by inpainting partial RGB textures. These approaches did not allow realistic modeling of avatars with clothing. More recent works on one-shot body modeling relied on implicit geometry and radiance models, which predict occupancy and color with the multi-layer perceptron conditioned on feature vectors extracted from the input image. While this line of work often manages to recover intricate geometric details, the realism of the recovered texture in the unobserved parts is usually limited.

The ARCH system uses the rigged canonical space to build avatars suitable for animations. ARCH++ improves the quality of resulting avatars by revisiting the major steps of ARCH. They also solve the challenge of unseen surfaces by synthesizing the back views of a person from the front view. PHORHUM improves the modeling of geometry by adding the reasoning about scene illumination and albedo of the surface. ICON uses local features to avoid the dependence of the reconstructed geometry on the global pose. Their approach first estimates separate models from each view and then merges the models using SCANimate. The method uses RGB textures applied to reconstructed geometry, which limits the rendering photo-realism.

An alternative approach to getting one-shot avatars is to use avatar generative models as proposed in StylePeople. The authors circumvent the need to reconstruct the unseen parts by exploiting the entanglement in the GANs latent space. Unfortunately, the imperfection of their underlying generative model often leads to implausible appearance of unobserved parts.

Diffusion models may be an alternative to generative models. In the human modeling domain, the diffusion models were shown to work very well for the task of human motion generation. RODIN employs a diffusion framework to generate non-rigged head avatars as neural radiance fields represented by 2D feature maps. TEXTure uses text guidance and a pre-trained diffusion model to produce a view-consistent RGB texture of a given geometry. However, to the best of authors' knowledge, diffusion models have not yet been used to generate neural textures for 3D objects.

### SUMMARY

Provided is a method to create photo-realistic animatable human avatars from a single photo.

Additional aspects will be set forth in part in the description which follows and, in part, will be apparent from the description, or may be learned by practice of the presented embodiments.

According to an aspect of an embodiment, a computer-implemented method of generating fullbody animatable avatar of a person from a single image of the person may include: obtaining an image of a person body and a parametric body model defined by pose parameters and shape parameters of the person body in the image, and by camera parameters used when capturing the image; defining, based on the parametric body model, a texturing function including a mapping between each pixel corresponding to a part of the person body shown in the image and corresponding texture coordinates in a texture space, and corresponding texture coordinates in the texture space for a part of the person body not shown in the image; sampling RGB texture of the person body based on the mapping and obtaining a map of sampled pixels, where the RGB texture includes: for each pixel corresponding to a part of the person body shown in the image, a corresponding pixel value, and one or more unshown texture regions corresponding to the texture coordinates for the part of the person body not shown in the image; passing the image of the person body through a trained encoder-generator network to generate texture of the person body shown in the image; concatenating the RGB texture, the map of sampled pixels, and the generated texture to obtain neural texture; inpainting unshown texture regions of the neural texture by a trained diffusion-based inpainting model; and translating a rasterized image of a fullbody avatar of the person body in a different pose by a trained neural renderer into a rendered image of the fullbody avatar of the person body in the different pose, where the rasterized image is obtained based on the inpainted neural texture and the mapping included in the texturing function, in which where the parametric body model is modified based on target pose parameters or target camera parameters, and where the target pose parameters or the target camera parameters correspond to the different pose of the fullbody avatar of the person body.

The method may further include inpainting, in the sampled RGB texture, gaps not exceeding a predetermined threshold size based on an average of neighbouring pixels to obtain a map of inpainted pixels, where the concatenating the RGB texture includes using the map of inpainted pixels to obtain the neural texture.

The inpainting unshown texture regions of the neural texture may include: adding Gaussian noise to the neural texture, and iteratively running a denoising procedure on the neural texture with the Gaussian noise, by the trained diffusion-based inpainting model, until the inpainted neural texture is shown and the Gaussian noise is not shown.

The parametric body model may be based on fixed-topology mesh driven by the pose parameters and the shape parameters.

An encoder of the trained encoder-generator network may be based on a StyleGAN2 discriminator and trained to compress an image to a feature vector, where a generator of the trained encoder-generator network is based on StyleGAN2 generator and trained to generate texture from the feature vector.

The mapping may be based on a UV unwrapping performed with a front cut of a representation of the person body in the image.

The method may further include detecting an occluded area of the person body in the image, and excluding the occluded area during the sampling of the RGB texture.

The trained diffusion-based inpainting model may include a Denoising Diffusion Probabilistic Model (DDPM) including denoising U-Net architecture trained to inpaint unshown texture regions of the neural texture to obtain the inpainted neural texture, where the denoising U-Net architecture includes BigGAN residual blocks for upsampling and downsampling, and attention layers on a number of feature hierarchy levels of the denoising U-Net architecture.

The trained diffusion-based inpainting model may further include a Vector Quantized Generative Adversarial Network (VQGAN) autoencoder including an encoder trained to encode the neural texture into a lower dimensional latent representation of the neural texture input to the denoising U-Net architecture, and a decoder trained to decode an output of the denoising U-Net architecture to the inpainted neural texture.

The method may further include training the encoder-generator network, the diffusion-based inpainting model, and the neural renderer, where the training includes: performing a first training stage at which the encoder-generator network and the neural renderer being based on a rendering U-Net architecture having ResNet blocks, which form a pipeline, are trained in an end-to-end manner based on multi-view image sets used as training data, the first training stage including: sampling two different images from a same set of the multi-view image sets, including a first image depicting a person body in a pose having input pose parameters used as an input image, and a second image depicting the person body in a pose having different target pose parameters used as a ground truth image, passing the first image and the target pose parameters through the pipeline being trained to render an image of an avatar of the person body in a pose having target pose parameters, calculating, based at least on the rendered image and the ground truth image, a loss value according to one or more loss functions among a difference loss between the rendered image and the corresponding ground truth image, a learned perceptual image patch similarity (LPIPS) loss between the rendered image and the corresponding ground truth image, a nonsaturating adversarial loss based on StyleGAN2 discriminator with R₁-regularization, or a Dice loss between a predicted segmentation mask and a ground truth segmentation mask, calculating gradients based on the loss value, and updating parameters of the encoder-generator network and the neural renderer based on the gradients; and based on the loss value according to the one or more of loss functions being minimized, fixing learned parameters of the encoder-generator network and the neural renderer and performing a second training stage at which the diffusion-based inpainting model including at least a denoising U-Net architecture is added to the pipeline and trained using conditional diffusion learning to inpaint unshown texture regions of the neural texture, the second training stage including: merging incomplete neural textures of two or more images covering different view angles and sampled from a same multi-view image set of the multi-view image sets used as training data to obtain a merged neural texture used as a ground truth neural texture, adding Gaussian noise to the merged neural texture in accordance with an unspecified step among a number of iterations at which a denoising procedure is performed by the trained diffusion-based inpainting model, concatenating, to the merged neural texture with the added Gaussian noise, an incomplete neural texture of the incomplete neural textures for obtaining the merged neural texture, passing the merged neural texture with the added Gaussian noise and with concatenated incomplete neural texture through the diffusion-based inpainting model predicting, for the unspecified step, a noise to be removed for obtaining the inpainted merged neural texture, calculating, based at least on the predicted noise to be removed and the added Gaussian noise, a loss value according to the one or more of loss functions, calculating gradients based on the loss value, and updating parameters of the denoising U-Net architecture used for diffusion-based inpainting based on the gradients; and based on the loss value being minimized, fine-tuning the pretrained pipeline.

The fine-tuning may include fixing weights and biases of the neural renderer, and propagating gradients from a differentiable neural renderer to RGB channels of the RGB texture, where the gradients are based on the loss value obtained at the first training stage.

The first training stage may further include: based on the VQGAN autoencoder being included in the trained diffusion-based inpainting model, training the VQGAN autoencoder to encode neural textures into lower dimensional latent representations of the neural textures, and decode lower dimensional latent representations of the neural textures by minimizing the loss value according to the one or more loss functions used at the first training stage, where, the second training stage is performed in a latent space of the pretrained VQGAN autoencoder.

The first training stage may further include calculating the difference loss and the LPIPS loss for an entire image, and with a predetermined weight for an image area corresponding to a face.

According to an aspect of an embodiment, a computing device may include: at least one processor; and a memory storing processor-executable instructions, and parameters including weights and biases of a trained pipeline of an encoder-generator network, a diffusion-based inpainting model, and a neural renderer, where the at least one processor is configured to execute the processor-executable instructions to perform a method of generating a fullbody animatable avatar of a person body from a single image of the person body, where the method may include: obtaining an image of the person body and an estimated parametric body model defined by pose parameters, shape parameters of the person body in the image, and camera parameters used when capturing the image; defining, based on the parametric body model, a texturing function including a mapping between each pixel corresponding to a part of the person body shown in the image and corresponding texture coordinates in a texture space, and corresponding texture coordinates in the texture space for a part of the person body not shown in the image; sampling RGB texture of the person body based on the mapping, and obtaining a map of sampled pixels, where the RGB texture includes: for each pixel corresponding to a part of the person body shown in the image, a corresponding pixel value, and one or more unshown texture regions corresponding to the texture coordinates for the part of the person body not shown in the image; passing the image through a trained encoder-generator network to generate texture of the person body shown in the image; concatenating the RGB texture, the map of sampled pixels and the generated texture to obtain neural texture; inpaint unshown texture regions of the neural texture by a trained diffusion-based inpainting model; and translate a rasterized image of the fullbody avatar of the person body in a different pose by a trained neural renderer into a rendered image of the fullbody avatar of the person body in the different pose, where the rasterized image is obtained based on the inpainted neural texture and the mapping included in the texturing function, in which the parametric body model is modified based on target pose parameters based on target camera parameters, and where the target pose parameters or the target camera parameters correspond to the different pose of the fullbody avatar of the person body.

According to an aspect of an embodiment, a computer-readable medium storing computer-executable instructions, and parameters including weights and biases of a trained pipeline of an encoder-generator network, a diffusion-based inpainting model, and a neural renderer, where by executing the computer-executable instructions, a computing device is configured to perform a method of generating fullbody animatable avatar of a person from a single image of the person, the method may include: obtaining an image of a person body and an estimated parametric body model defined by pose parameters and shape parameters of the person body in the image, and camera parameters used when capturing the image; defining, based on the parametric body model, a texturing function including a mapping between each pixel corresponding to a part of the person body in the image and corresponding texture coordinates in a texture space, and corresponding texture coordinates in the texture space for a part of the person body not shown in the image; sampling RGB texture of the person body based on the mapping and obtaining a map of sampled pixels, where the RGB texture includes: for each pixel corresponding to a part of the person body in the image, a corresponding pixel value, and one or more unshown texture regions corresponding to the texture coordinates for the part of the person body not shown in the image; passing the image through a trained encoder-generator network to generate texture of the person body shown in the image; concatenating the RGB texture, the map of sampled pixels and the generated texture to obtain neural texture; inpainting unshown texture regions of the neural texture by a trained diffusion-based inpainting model; translating a rasterized image of the fullbody avatar of the person body in a different pose by a trained neural renderer into a rendered image of the fullbody avatar of the person body in the different pose, where the rasterized image is obtained based on the inpainted neural texture and the mapping included in the texturing function, in which the parametric body model is modified based on target pose parameters or target camera parameters, and where the target pose parameters or the target camera parameters correspond to the different pose of the fullbody avatar of the person.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart of the computer-implemented method of generating fullbody animatable avatar of a person from a single image of the person according to an embodiment;

FIG. 2 is a schematic non-limiting representation of an overall pipeline proposed for the computer-implemented method of generating fullbody animatable avatar of a person from a single image of the person according to the first aspect of the present application.

FIG. 3 is a schematic non-limiting representation illustrating the operation and other details of the proposed diffusion-based inpainting model including the VQGAN autoencoder and the denoising U-Net architecture used in the method according to an embodiment;

FIG. 4 is a schematic representation of the non-limiting implementation of an encoder E architecture from an encoder E-generator G network used in the method according to an embodiment;

FIG. 5 is a schematic representation of the non-limiting implementation of a neural renderer θ used in the method according to an embodiment;

FIG. 6 is a simplified representation of the step of merging neural textures for obtaining a complete neural texture based on different images of a multi-view image set covering different view angles according to an embodiment;

FIG. 7 is a schematic representation of a step of detecting an occluded area of person body in the image Irgb according to an embodiment;

FIG. 8 is an illustration of fullbody-animated avatars of persons in different poses generated by the method based on corresponding single images according to an embodiment; and

FIG. 9 is a schematic non-limiting representation of a computing device according to the second aspect of the present application.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Diffusion models are probabilistic models for learning the distribution of p(x) by gradual denoising of a normally distributed variable. Such denoising corresponds to learning the inverse process for a fixed Markov chain of length T^{noise}. The most successful models for image generation use the reweighted variant of the variational lower bound on p(x). These models can also be interpreted as denoising autoencoders ε_{ω(x}_{ₜ}_{,t);t=1 . . . T}_{^{noise}} with shared weights. These autoencoders can be learned to predict xt−1 with reduced noise level over xt. Such denoising models can be trained with a simplified loss function:

$$[ {L}_{D M} = {𝔼}_{x , ∈ ∼ N ( 0.1 ) , t} [ {‖ ϵ - {ϵ}_{ω} ( {x}_{t} , t ) ‖}_{1}^{1} ] ]$$

where E (expected value) represents an averaging operation, t is uniformly sampled from {1, . . . , T^{noise}}, ∈ is noise from the normal Gaussian distribution N(0, 1) with mean being 0 and variance being 1, ∈_{w} is noise predicted by denoising U-Net having trainable parameters w. Generally, at each step of training, the denoising U-Net takes as input a noisy image xt and a step number t corresponding to an amount of Gaussian noise added and predicts noise to be removed to obtain a denoised image. Then, L₁ loss is calculated between the added Gaussian noise and the predicted noise. For neural texture inpainting the method according to the present application uses latent diffusion, which has been shown to be effective in inpainting of RGB images. The term “neural texture” as used herein means, in general, a texture having an arbitrary number of channels, which values are tailored by gradient methods based on the loss (error) function calculation. Rendering such a texture to RGB is performed by a neural renderer, which converts a rasterized 3D model (i.e. mesh) with such a texture to RGB image.

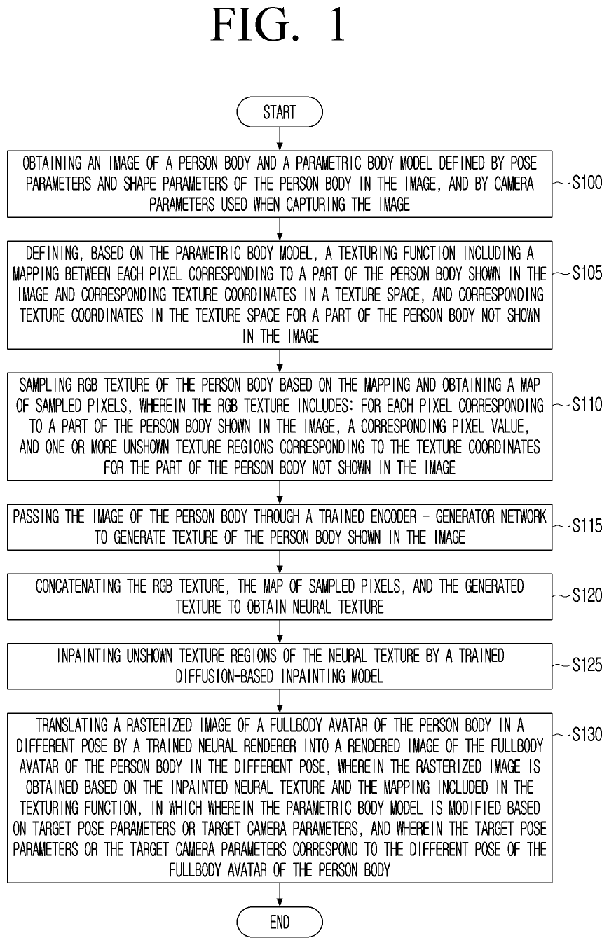

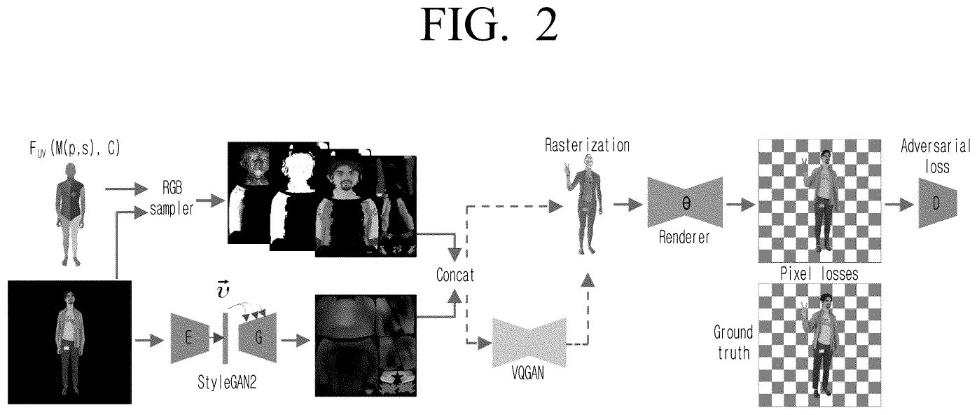

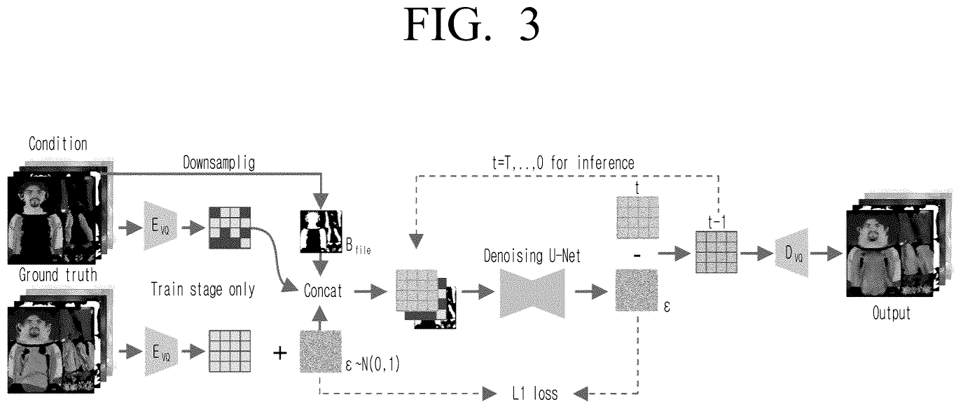

A computer-implemented method of generating fullbody animatable avatar of a person from a single image of the person has two main parts: avatar generation components and diffusion-based inpainting model. Such a division is not mandatory but is used in this application for ease of explanation. The flowchart of the proposed method is illustrated in FIG. 1. FIG. 2 is a schematic non-limiting representation of an overall pipeline used by the method, in said representation the diffusion-based inpainting model is schematically represented by the ‘VQGAN’ block, while everything else shown in FIG. 2 corresponds to the avatar generation components. FIG. 3 is a schematic non-limiting representation illustrating the operation and other details of the proposed diffusion-based inpainting model.

Generally, the proposed method reconstructs the neural texture from the input image of a person using two pathways and then uses the texturing operation as well as the neural rendering to synthesize plausible images of the avatar corresponding to the person in different poses and, if necessary, under different view angles. A sequence of said plausible images may be used to animate the avatar. The inpainting model is called herein as namely “diffusion-based inpainting model” because it is trained based on Denoising Diffusion Probabilistic Model (DDPM) on top of the pretrained avatar generation components.

The method according to the first aspect of the present application generates 3D rigged avatars of clothed human using a pipeline comprising at least an encoder E-generator G network, the diffusion-based inpainting model, and a neural renderer trained together in the end-to-end fashion. The method obtains at step S100 as input an RGB image I_{rgb} and a parametric body model. In an embodiment, the parametric body model is a parametric SMPL-X body model. However, other parametric body models known in the art may well be used. During training, SMPL-X models are fitted to the train images using an implementation of SMPLifyX approach with an additional segmentation Dice loss between predicted segmentation mask and ground truth segmentation mask that allows to match human silhouettes better.

In more detail, in an embodiment of the present disclosure an SMPL-X fixed-topology mesh M (p; s) driven by sets of pose parameters p and shape parameters s is used. For texture mapping UV-map function FUV (M (p_{target}, S), C_{target}) is defined at step S105 of the method. For SMPL-X, a customized UV unwrapping with a front cut may, optionally, be used to avoid difficult to inpaint back-view seams. However, different types of cuts may be used as well. The rendering process takes the mesh M and the desired camera parameters C_{target} as input. The pose parameters p_{target} may be used to rig the mesh. The texturing function F_{UV} generates a UV-map of size H×W×2, where H and W determine the size of the output image, and for each (seen or unseen) pixel the texture coordinates [i, j] on the L-channeled texture T are specified. In other words, the UV-map may be considered as a two-channel “texture”, which specifies which texel (texture element) corresponds to which vertex of the body model. Thus, the texturing function F_{UV} may be used in the rasterizer R (F_{UV}, T) to map the pixels in the output image to the features of the texels of the neural texture T. The rasterizer R thus produces the image of size H×W×L.

Parameters of the rasterizer R may be set so that H and W correspond to the height and width of the input RGB image I_{rgb}. In this case, the UV-map function FUV can be used not only to map feature vectors from the neural texture T, but also to sample color values from the input image I_{rgb} into the texture space: T_{rgb}=ξ(F_{UV} (M (pᵢₙₚᵤₜ, S), Cᵢₙₚᵤₜ), I_{rgb}). Here, the number of channels L=3, and pᵢₙₚᵤₜ corresponds to the pose of the person (human) in I_{rgb}, and Cᵢₙₚᵤₜ are parameters of the camera restored from I_{rgb}. The mapping ξ transfers the color value from I_{rgb} to the texture T_{rgb} point specified by F_{UV} at step S110 of the method. This RGB texture advantageously allows to explicitly save information about high-frequency details and original colors (as discussed below), which are hard to preserve when mapping the whole image to a vector of limited dimensionality. Additionally, a simple filling with an average value may be needed to remove the gaps that appear on the texture due to the discreteness of sampling grid. Thus, inpainting of small gaps (e.g. gaps not exceeding a predetermined threshold size of n pixels, where n is equal to, e.g., 20 pixels or less, 15 pixels or less, 10 pixels or less, 5 pixels or less, 2 pixels or even a pixel) may be, optionally, applied e.g. by averaging neighbouring pixels to fill the gaps in T_{rgb}. The binary map Bₛₘₚ of sampled pixels and the binary map B_{fill} of sampled and inpainted pixels may be saved for subsequent use for neural texture generation.

To sample RGB texture at step S110 of the method the following non-limiting RGB texture-sampling algorithm with averaging of pixels neighbouring a gap(s) may be used:

Algorithm 1 RGB texture sampling algorithm

Require: RGB (size × size × 3)
Require: UV (size × size × 2)
# Initialize texture with zeros
T ← zeros (texture_size × texture_size × 3)
C ← zeros (texture_size × texture_size)
# Fill texels with mean value of neighbors
for ∀x, y ∈ [0..size] do
(i, j) ← UV [x; y]
for ∀k, m ∈ [−1, 0, 1] do
T [i + k, j + m] += RGB[x; y]
C [i + k, j + m] += 1
end for
end for
T = T/C
# Fill exact values in texels for which inpainting is not required
for ∀x, y ∈ [0..size] do
(i, j) ← UV [x; y]
T [i, j] ← RGB[x; y]
end for

The above Algorithm 1 should not be interpreted as the only possible algorithm for RGB texture sampling algorithm, since a skilled person in the art will be able to come up with a different algorithm implementing the same or similar functionality. Thus, the above Algorithm 1 should be interpreted as a non-limiting example.

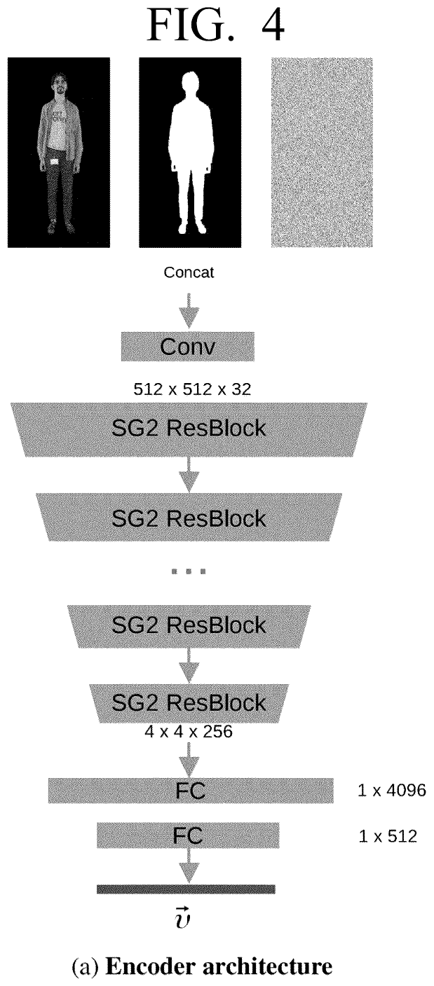

The main part of the neural texture is T_{gen}. It has the number of channels L=16 and is generated at step S115 of the method using the trained encoder E-generator G network. Thus, T_{gen}=G (E (I_{rgb})). The encoder E compresses the input image I_{rgb} to a feature vector \vec{υ}. The non-limiting implementation of the encoder E architecture is schematically represented in FIG. 4. As the encoder E architecture authors of the present disclosure adapted StyleGAN2 discriminator architecture with a few changes. Namely, three inputs are fed to the network input: RGB image I_{rgb}, segmentation mask S, and additional single-channel noise. Additional single-channel noise is introduced to provide additional freedom to the generative model when training the GAN. The efficiency of using noise in generative neural networks has been demonstrated by the authors of StyleGAN. The images received at the input are concatenated by channels and passed through a feature extractor with an architecture equivalent to the StyleGAN discriminator comprising ResNet blocks. The model head was modified to output a feature vector \vec{υ} of dimension 512. This vector is then used as the input of the generator G (\vec{υ}) and the proposed encoder is trained end-to-end with the generator and the renderer. The generator G (\vec{υ}) has the architecture of the StyleGAN2 generator and converts the feature vector T′ into the main part T_{gen} of the neural texture. T_{gen} has the number of channels L=16 as in StylePeople.

The final (but not inpainted for unseen texture regions) neural texture T used in the method has a dimension of 256×256×20 or 256×256×21. The final neural texture T is obtained at step S120 of the method by concatenating the RGB texture T_{rgb} (256×256×3), the map Bₛₘₚ of sampled pixels, the generated texture T_{gen} (256×256×16), and, optionally, the map B_{fill} of inpainted pixels:

$$[ T = {T}_{g e n} ⊕ {T}_{r g b} ⊕ {B}_{s m p} , or \qquad ( 2 a )$$

$$T = {T}_{g e n} ⊕ {T}_{r g b} ⊕ {B}_{s m p} ⊕ {B}_{fill} ] \qquad ( 2 b )$$

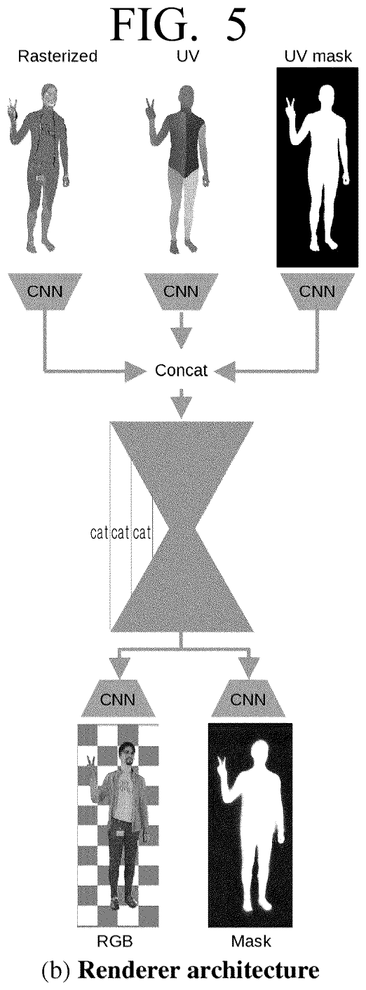

Once the final neural texture is obtained the method proceeds to step S125 of inpainting unseen texture regions of the neural texture T by the trained diffusion-based inpainting model to obtain T_{inpainted}. Then, the neural renderer θ (R (F_{UV}, T_{inpainted})) translates at step S130 of the method the rasterized image R (F_{UV}, T_{inpainted}) with L channels into output RGB image I_{rend}. The neural renderer θ has the U-Net architecture with ResNet blocks. The non-limiting implementation of the neural renderer θ is schematically represented in FIG. 5. The neural renderer θ takes three images as input: a rasterized image R of the SMPL-X body model with the inpainted neural texture T_{inpainted}, a UV-render, and a UV-mask. The UV-render represents a rasterized 3D model (i.e. mesh) in the form of a two-channel image, where each pixel is a coordinate on the texture, from where a corresponding color value is taken. The UV-mask specifies, in which pixels of the UV-render texture coordinates are set, and in which pixels of the UV-render texture coordinates are not set. In the latter case, pixels having no texture coordinates set may be specified in the UV-mask with e.g. ‘0’ value. Each input image is passed through a convolutional network consisting of two convolutions with LeakyReLU activation and BatchNorm layers. Output features are concatenated and fed into a U-Net comprising ResNet blocks. The U-Net has 3 levels connected by feature concatenation. The U-Net output is passed through two additional convolutional networks to predict the rendered RGB image I_{rend} of the avatar and its mask.

Thus, the rasterized image R may be obtained from the inpainted neural texture T_{inpainted} and the mapping specified by the texturing function F_{UV}, in which the parametric body model is modified based on target pose parameters p_{target} and/or camera parameters are modified to target camera parameters C_{target}. The target pose parameters p_{target} and/or the target camera parameters C_{target} correspond to said new pose of the fullbody avatar of the person. It should be clear that throughout the present materials the concept of “a new pose of the fullbody avatar of the person” includes any poses of the person avatar obtainable by modifying at least one parameter of pose parameters and/or at least one parameter of camera parameters. Thus, a new pose of the fullbody avatar of the person, which is obtained by modifying only camera parameter(s) is still considered as the new pose of the fullbody avatar of the person even though the person's pose in the image remained unchanged.

The neural renderer is trained jointly with the encoder E-generator G network. Thus, rendering a fullbody avatar of a person in a new pose p_{target} based on a single input RGB image I_{rgb} depicting the person in the pose pᵢₙₚᵤₜ may have the following form:

$$[ {T}_{i npainted} = G ( E ( {I}_{r g b} ) ) ⊕ ξ ( {F}_{U V} ( M ( {p}_{i nput} , s ) , {C}_{i nput} ) , {I}_{r g b} ) ⊕ {B}_{s m p} , or \qquad ( 3 a )$$

$${T}_{inpainted} = G ( E ( {I}_{r g b} ) ) ⊕ ξ ( {F}_{UV} ( M ( {p}_{i nput} , s ) , {C}_{i nput} ) , {I}_{r g b} ⊕ {B}_{s m p} ⊕ {B}_{fill} \qquad ( 3 b )$$

$${I}_{rend} = θ ( R ( {F}_{UV} ( M ( {p}_{target} , s ) , {C}_{target} ) {T}_{inpainted} ) ) ] \qquad ( 4 )$$

During training, one or more of the following losses is minimized: difference loss L₂ between the rendered image I_{rend} and the corresponding ground truth image I_{GT}, Learned Perceptual Image Patch Similarity, LPIPS, loss between the rendered image I_{rend} and the corresponding ground truth image I_{GT}, nonsaturating adversarial loss based on StyleGAN2 discriminator with R₁-regularization, and Dice loss between predicted segmentation mask S_{pred} and ground truth segmentation mask S_{GT}. In one embodiment, the combination of all the above-mentioned loss function is minimized (see math. expression (5) below). The difference loss L₂ and LPIPS loss are calculated for the entire image and may be additionally calculated with a weight for the area with a face, since the face is very important for human perception. The weight in an embodiment is equal to 0.1, but in other embodiments it may be more (e.g., from 0.11 to 0.2) or less (e.g., from 0.09 to 0.01). The nonsaturating adversarial loss may be used to make I_{rend} look more plausible and sharper. Said nonsaturating adversarial loss Adv may be used with the StyleGAN2 discriminator D with R₁-regularization. The overall loss used in an embodiment may thus has the following form:

$$[ Loss = {λ}_{1} \cdot {‖ I - {I}_{r e n d} ‖}_{2}^{2} + {λ}_{2} \cdot LPIPS ( {I}_{G T} , {I}_{r e n d} ) + {λ}_{3} \cdot Dice ( {S}_{G T} , {S}_{p r e d} ) + {λ}_{4} \cdot Adv ( D ( {I}_{r e n d} ) ) + {λ}_{5} \cdot {R}_{1 reg} ] \qquad ( 5 )$$

The choice of hyperparameters λ_{1 . . . 5} will be described below.

Several techniques may optionally be applied to improve avatar quality in the inference stage. To enhance the texture details in the visible part, several (namely 64) optimization steps of RGB channels may be performed with gradients from the differentiable renderer for the input image. Specifically, to achieve this, gradients from the neural renderer θ derived by comparing the rendered image I_{rend} with the input RGB image I_{rgb} may be used. Such gradients may be applied to texels with weights that correspond to angles between the normal vectors and the camera direction, which will be discussed in detail with reference to FIG. 5 below. This makes sure that only texels that can be seen in the input image I_{rgb} are optimized with prioritization of more frontal ones. The difference loss L₂ and LPIPS loss may be used to encourage color matching, whereas the adversarial loss Adv with R₁-regularization analogous to one used in the overall loss math. expression (5) may be used to amplify detalization.

Also optionally applicable is a linear adjustment to the RGB channels of the VQGAN (FIG. 3) decoding output to improve color matching between front and back views after the inpainting stage:

$$[ {T}_{r g b} = {T}_{r g b} α + β ] \qquad ( 8 )$$

In this case, all texels share the trainable parameters alpha and beta optimizable with neural renderer's gradients derived by the pixels visible in the input image I_{rgb}. As a result, the RGB channels of the neural texture at the VQGAN output strengthen color matching with the sampled RGB texture T_{rgb}. This make it possible to minimize the seam(s) after combining textures.

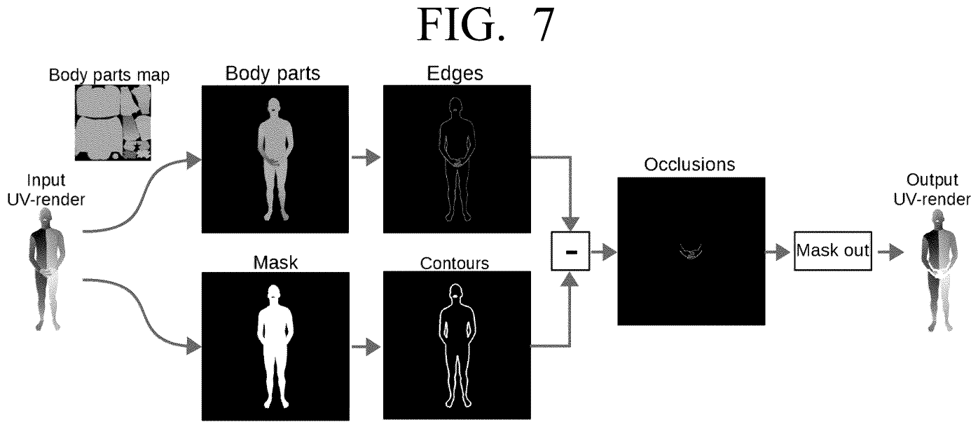

Additionally, since SMPL-X meshes are imperfect, there is a problem of SMPL-X fitting imperfections, where pixels are wrongly sampled from one body part to another at the self-occluded areas (e.g., hands in front of the body). These SMPL-X fitting imperfections may result in implausible renderings. To address this issue, occluded areas of person body, including human self-occlusions, are detected in the input image I_{rgb} and the texture within the overlap outline is not sampled at step S110 of the method. Not sampled texture comprised within the overlap outline as well as all other unseen texture regions are then subject to inpainting at step S125 of the method. As illustrated in FIG. 7, in one implementation rasterization with a colormap may be employed as a texture to find overlapping regions. Specifically, a separate color may be assigned to each limb in the colormap and the transition between the limbs may be made smooth using a color gradient. This enables to avoid having seams in the rasterization. Edges in the colormap rasterization may be detected with Canny algorithm or with any other edge-detecting algorithm known in the art. Person's contours may then be determined with the use of binarized SMPL-X rasterization. By taking the contours out of edges, a map of occluded area(s) of person body is obtained. The resulting map is then used to mask out areas in the UV-render. This enables to rely on inpainting in later pipeline steps rather than sampling pixels in overlapped areas.

Training is performed on multi-view image sets such as sets of frames of the video (or such as sets of renders of 3D models). In a non-limiting implementation of training at a first training stage, in each training step two different frames are taken from a same set, one serves as an input image I_{rgb} with input pose parameters pᵢₙₚᵤₜ and the other one as a target image with target pose parameters p_{target} and/or target camera parameters C_{target}. The two images are thus having different camera parameters as well as two different body pose parameters of a same person. In an implementation of the training two frames may be sampled from a same multi-view image set such that differences in pose parameters and/or camera parameters between the two images are greater than or equal to respective predetermined minimum difference threshold(s) to avoid images having insufficient differences in pose parameters and/or camera parameters from being sampled. This is essential for the pipeline to generalize to new camera positions C and poses p. To accomplish that, the neural renderer θ and the encoder E-generator G network learn to inpaint texture regions unseen in I_{rgb}.

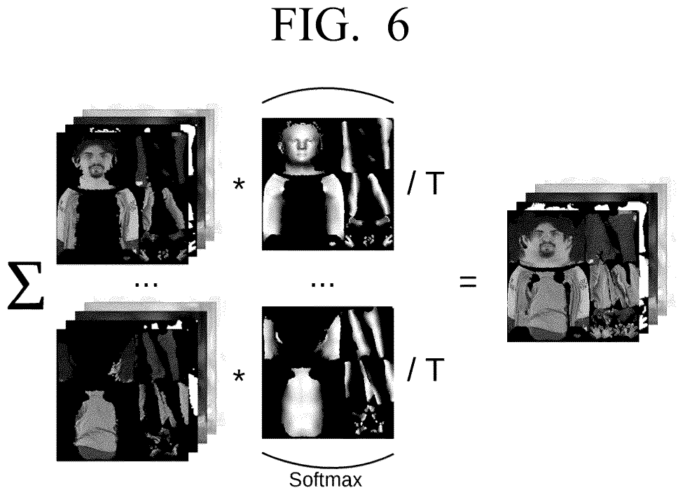

While the neural renderer θ and the encoder E-generator G network learn to compensate for the small amount of the unseen texture regions that may be present in the target view, it has been found that such ability is mainly limited to small changes in body pose and/or camera parameters. The easiest way to obtain an avatar that can be rendered from arbitrary angles is to create it from several images by merging the corresponding neural textures. For that, a simple blending scheme schematically illustrated in FIG. 6 may be used. Specifically, assume the N input images I_{rgb}ⁱ of a person with different camera parameters Cᵢₙₚᵤₜⁱ are given that result in N neural textures Tⁱ. These textures naturally cover different areas of the person body visible in different input images. To combine these textures, the function F (T¹ . . . T^{N}, λ¹ . . . λ^{N}) schematically illustrated in FIG. 6 may be used. The λⁱ is auxiliary information about the texture region seen or visible in the corresponding input image I_{rgb}ⁱ.

As auxiliary information λⁱ angles between the normal vectors of corresponding point of the mesh Mⁱ and direction vector of the camera may be used. Thus, Ni defines how frontal each texture point is to the camera. Texture merging is performed with utilization of this information, emphasizing more frontal pixels for each Tⁱ. Then textures Tⁱ are aggregated using weighted average with weights calculated as

$$\vec{w} = softmax ( \frac{\vec{λ}}{τ} ) .$$

The τ factor controls the sharpness of edges at the junction of merged textures. It should be noted that weights can be calculated in a different way. The final merged texture thus may be calculated as follows:

$$[ F ( {T}^{1} … {T}^{N} , {λ}^{1} … {λ}^{N} ) = {\sum }_{i = 1}^{N} {T}^{i} \cdot {w}^{i} ] \qquad ( 6 )$$

This technique allows to get few-shot avatars by merging one-shot avatars for different views. More sophisticated blending schemes such as pyramid blending, or Poisson blending can be also used.

As the final piece of the method proposed herein, the diffusion-based inpainting model comprising a denoising U-Net architecture and, optionally, a VQGAN autoencoder. The diffusion-based inpainting model may be trained using supervised learning, where incomplete textures based on single photographs are used as inputs and the merged textures aggregated from multiple views are used as ground truth images.

Importantly, since the distribution of plausible (“correct”) complete textures given the input partial texture is usually highly complex and multi-modal, authors of the present disclosure proposed to use the Denoising Diffusion Probabilistic Model, DDPM, framework and train a denoising U-Net architecture instead of the direct mapping from the input to the output. As described above, in the non-limiting implementation the neural texture T has a resolution of 256×256×20 (without the map B_{fill} of inpainted pixels) or 256×256×21 (with the map B_{fill} of inpainted pixels). This leads to a huge memory requirements during the diffusion model training. To reduce memory consumption and improve the network convergence, first, the neural texture size may be reduced using the VQGAN autoencoder. As demonstrated in FIG. 2 the VQGAN autoencoder is added as an alternative branch for the input of the neural renderer θ. After the pretraining of the VQGAN autoencoder, the pipeline may be fine-tuned end-to-end in order to adapt the neural renderer θ to the VQGAN autoencoder decompression artifacts in the inpainted neural texture T_{inpainted}. Several loss functions may be used to train the VQGAN autoencoder to restore neural textures more accurately. To improve the visual quality of the avatar after texture decompression, the loss functions in the RGB space may be used. During training, the avatar is rendered as described in expression (4) specified above with the inpainted neural texture T_{inpainted} and the loss function (5) is then optimized. Additional L₂ loss in the texture space ∥T−T_{inpainted}∥₂² may be used for additional regularization and preservation of neural texture properties for all views.

After adding the VQGAN autoencoder to the neural texture-inpainting pipeline as illustrated in FIG. 3, the denoising U-Net architecture based on the DDPM model is trained in the latent space of the pretrained VQGAN autoencoder. Thus, the denoising U-Net architecture based on the DDPM model is applied to T_{c}⁰=V (T⁰) with size 64×64×3, obtained after the compression of the single-view based neural texture by the VQGAN encoder E_{VQ}. The denoising U-Net architecture based on the DDPM model may be trained with attention, e.g. with one or more attention layers. The denoising U-Net architecture is conditioned with E_{VQ}(T⁰)⊕b(B_{fill}⁰), where b is a bilinear resize to the spatial size of T_{c}⁰. Thus, the concatenation of the condition and the texture T_{c} corrupted with normally distributed (Gaussian) noise corresponding to the diffusion timestep t is fed to the denoising U-Net architecture as the input. The denoising U-Net architecture thus trains to denoise the input by minimizing the loss L_{DM} (1). As already explained above L_{DM} may be based on L₁ loss function.

As mentioned above, the diffusion-based inpainting model illustrated in FIG. 3 is trained using merged neural textures (FIG. 6) serving as the ground truth neural textures. Here, the merged neural textures may be generated from a multi-view dataset of 3D human scans. Multi-view dataset of people photographs with good angle coverage could be used as training data as well. As mentioned above the denoising U-Net architecture restores the texture T_{c} (namely its latent representation) from the noise based on the condition. Then, the texture T_{c} is transformed into the restored full-size neural texture T using the VQGAN decoder D_{VQ}. To retain all the details from the input image I_{rgb}, the restored neural texture T is then merged with the input texture T⁰ using the B_{fill}⁰ mask to obtain the inpainted neural texture T_{inpainted}:

$$[ {T}_{i npainted} = T \cdot ( 1 - {B}_{f i l l}^{0} ) + {T}^{0} \cdot {B}_{f i l l}^{0} ] \qquad ( 7 )$$

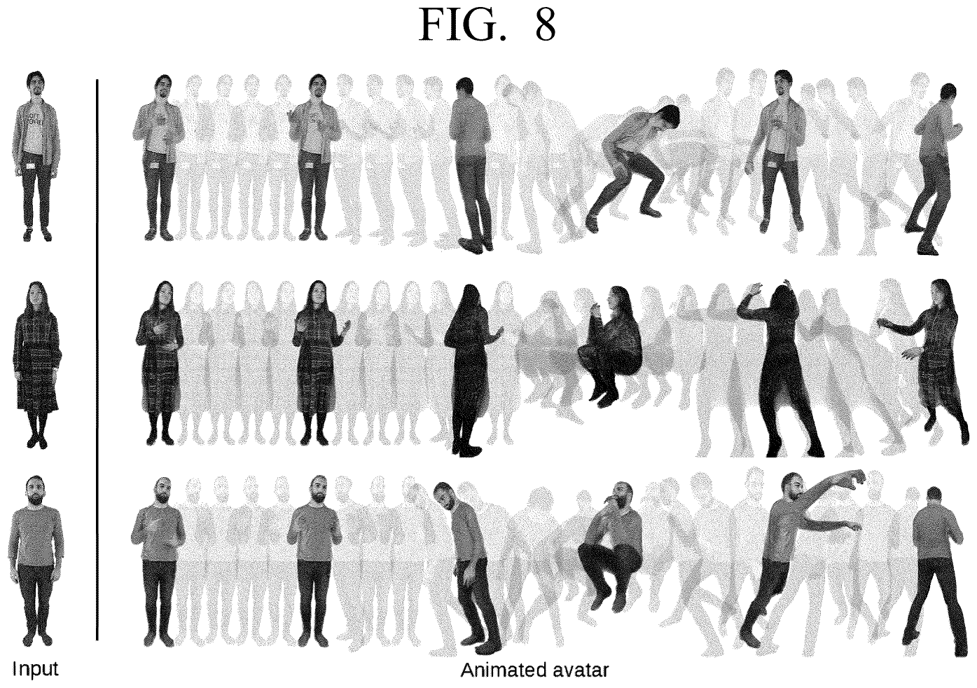

The resulting texture has all the details visible in the input image I_{rgb}⁰, while the parts of a person unseen in the input image I_{rgb}⁰ are restored by the diffusion-based inpainting model in the VQGAN autoencoder latent space. Examples of fullbody-animated avatars of persons in different poses generated by the above-described method are given in FIG. 8 for corresponding single input images I_{rgb} shown in the left side of the figure.

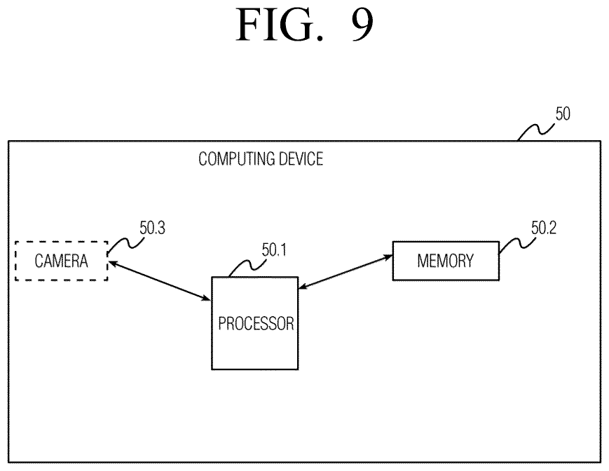

FIG. 9 is a schematic non-limiting representation of a computing device 50 according to the second aspect of the present application. As should be clear the computing device 50 may be configured to execute the above-described method according to the first aspect or according to any development of the first aspect. The computing device 50 comprises a processor 50.1 and a memory 50.2 storing processor-executable instructions, and parameters comprising at least weights and biases of the trained pipeline of the encoder E-generator G network, the diffusion-based inpainting model, and the neural renderer θ. Upon execution of the processor-executable instructions by the processor 50.1, the processor 50.1 causes the computing device 50 to carry out the method of generating fullbody animatable avatar of a person from a single image of the person according to the first aspect or according to any development of the first aspect.

The computing device 50 may be of any type, e.g., it may include, but without the limitation, a general-purpose computer, a dedicated computer, a computer network, a notebook, a smartphone, a tablet, a smartwatch, smart glasses, AR/VR headset, or another programmable apparatus. The processor 50.1 may be of any type. The processor 50.1 may include, but without the limitation, one or more of the following processors: a general purpose processor (e.g. CPU), a digital signal processor (DSP), an application processor (AP), a graphics-processing unit (GPU), a vision processing unit (VPU), a dedicated AI processor (e.g. NPU). The processor may be implemented as a System on Chip (SOC), Application Specific Integrated Circuit (ASIC), Field Programmable Gate Array (FPGA), or other Programmable Logic Device (PLD), discrete logic element, transistor logic, discrete hardware components, or any combination thereof. The processor may be subdivided into units each performing one or more steps of the above-described method.

The memory 50.2 may include, but without the limitation, Read-Only Memory (ROM) and Random Access Memory (RAM). Any types of RAM and ROM may be used. The computing device 50 may further comprise a camera 50.3 of any type capable of capturing images. The computing device 50 may operate on any operating system and may include any other necessary software, firmware, and hardware (e.g., communication unit, I/O interface, a camera, a power supply and so on).

It may be clearly understood by a person skilled in the art that, for the purpose of convenient and brief description, for a detailed working process of the foregoing computing device 50, refer to a corresponding process in the foregoing method embodiments. Details are not described herein again.

Training data and networks training data will now be discussed. The particulars discussed below should not be construed as a limitation. Instead, the below description and non-limiting examples may be considered to be given in support of sufficiency of disclosure of the present disclosure. The encoder E-generator G network, the diffusion-based inpainting model, the neural renderer θ or any aspect of their training may be implemented using open-source machine learning libraries such as, for example, TensorFlow, Keras, PyTorch and so on. Training may be performed offline or online. Training the pipeline of the encoder E-generator G network, the diffusion-based inpainting model, and the neural renderer θ was performed on RGB images having 512×512 resolution. Nevertheless, the resolution of the training RGB images may be more or less than the specified 512×512 resolution. For each 3×512×512 input image, 21×256×256 neural texture was generated. In the neural texture, the first 16 channels were generated by the generator G of the trained encoder E-generator G network, the next three channels were RGB channels, and the remaining two channels were the sampling and the inpainting masks. The generator G has the StyleGAN2 architecture and takes as input feature vector \vec{υ} generated by the encoder E of the trained encoder E-generator G network. The encoder E has the StyleGAN2 discriminator architecture with a modified head to output a vector of length 512. The resulting texture was applied to the SMPL-X model and rasterized. The rasterized image had a size of 21×512×512 and was fed to the neural renderer θ having U-Net architecture with ResNet blocks. The output of the neural renderer θ was a final image with the resolution of 3×512×512. The generator G and the neural renderer θ were trained end-to-end with the batch size of four. Nevertheless, the batch size may be more or less that four.

For training a combination of one or more loss functions may be used (in some embodiments all of the following loss functions may be used): difference loss L₂ between the rendered image I_{rend} and the corresponding ground truth image I_{GT}, learned perceptual image patch similarity (LPIPS) loss between the rendered image I_{rend} and the corresponding ground truth image I_{GT}, nonsaturating adversarial loss based on StyleGAN2 discriminator with R₁-regularization, and Dice loss between predicted segmentation mask S_{pred} and ground truth segmentation mask S_{GT}. In an embodiment, a weighted sum of the above losses was used with the following weights: the difference loss L₂ with λ₁=2.2; LPIPS loss with λ₂=1.0; Dice loss with λ₃=1.0; Adversarial loss with λ₄=0.01. It should be noted that the above-mentioned values of weights should not be interpreted in a limiting sense, because the method may well achieve the technical result(s) with modified weights. Such a modification should become apparent to one of ordinary skill in the art upon reading this disclosure. Lazy regularization R₁ was applied every 16 iterations with the weight λ₅=0.1. To calculate LPIPS loss, random 256×256 crops of the 512×512 images were taken. The pipeline of the encoder E-generator G network, the diffusion-based inpainting model, and the neural renderer θ was trained for 100,000 steps using the ADAM optimizer with 2e-3 learning rate.

The VQGAN autoencoder was trained to compress neural textures to 6×64×64 tensors consisting of vectors of length six from a trainable dictionary with 8192 elements. First, the VQGAN autoencoder was trained for 300,000 steps. Then the pipeline (with added pretrained VQGAN autoencoder) was fine-tuned end-to-end for additional 20,000 steps to reduce the neural renderer θ artifacts when processing neural textures processed by the VQGAN autoencoder. After that, the diffusion-based inpainting model was trained to restore missing parts of the texture. In the diffusion-based inpainting model the denoising U-Net architecture was used with the BigGAN residual blocks for up- and downsampling and with attention layers on three levels of its feature hierarchy. To additionally prevent overfitting, dropout was used with a probability of 0.5 in the residual blocks of the denoising U-Net architecture. The diffusion-based inpainting model was trained for 50,000 iterations with AdamW optimizer with a batch size of 128 and a learning rate of 1,0e-6.

To train the pipeline only 2D images obtained by rendering Texel dataset were used. The generator G of the encoder E-generator G network and the neural renderer θ were pretrained using 2D images of 13,000 people in diverse poses. It had been noticed that diverse poses are crucial to train realistically animatable avatars. For each image, a segmentation mask was obtained using Graphonomy segmentation and the SMPL-X parametric body model was fitted using SMPLify-X. To improve the body shape of fitted SMPL-X parametric body model a segmentation Dice loss was additionally used.

To train the VGQAN autoencoder and the diffusion-based inpainting model, renders from Texel dataset were used. 3333 human scans were acquired from the Texel dataset. They depict people in different clothing with various body shapes, skin tones and genders. Each scan was rendered from 8 different views (or camera view angles) to get a multi-view dataset. The renders were also augmented with camera angle changes and color shifts. Thus, for each person in the dataset, there were 72 scans. Note that any images from different views are suitable for training the model, not necessarily obtained from 3D scans.

The generated avatars and their animations were qualitively evaluated on AzurePeople dataset. This dataset contains diverse dressed people standing in natural poses. Additionally the trained pipeline was quantatively evaluated on the SnapshotPeople public benchmark. It contains 24 videos of people rotating in A-pose. Frames with front and back views were sampled from each video to measure the accuracy of back reconstruction. For each image, a segmentation mask and SMPL-X fit were obtained as described above.

Quantitative results. The quantitative comparison is shown below in Table 1:

Table 1: Metrics comparison on the SnapshotPeople benchmark. The method disclosed herein is compared not only with other parametric model based approaches (StylePeople), but also with approaches that restore geometry and require using additional methods for rigging (PIFu, Phorhum) or restore geometry in the canonical pose (ARCH, ARCH++).

Table 1: Metrics comparison on the SnapshotPeople benchmark. The method disclosed herein is compared not only with other parametric model based approaches (StylePeople), but also with approaches that restore geometry and require using additional methods for rigging (PIFu, Phorhum) or restore geometry in the canonical pose (ARCH, ARCH++).

TABLE 1
Metrics comparison on the SnapshotPeople benchmark. The method disclosed herein is
compared not only with other parametric model based approaches (StylePeople), but
also with approaches that restore geometry and require using additional methods for
rigging (PIFu, Phorhum) or restore geometry in the canonical pose (ARCH, ARCH++).

| | Same view | | | | Novel view | | |
|---|---|---|---|---|---|---|---|
| Method | MS-SSIM ↑ | PSNR ↑ | LPIPS ↓ | DISTS ↓ | KID ↓ | ReID ↓ | DISTS ↓ |
| PIFu | 0.9793 | 26.2828 | 0.0404 | 0.0706 | 0.1839 | 0.09769 | 0.0907 |
| Phorum | 0.9603 | 24.2112 | 0.0531 | 0.0948 | 0.1564 | 0.09149 | 0.0144 |
| ARCH | 0.9223 | 20.6499 | 0.0732 | 0.1432 | 0.2039 | 0.09575 | 0.0974 |
| ARCH++ | 0.9526 | 22.5729 | 0.0540 | 0.0842 | 0.1750 | 0.09098 | 0.0589 |
| StylePeople | 0.9282 | 20.5374 | 0.0731 | 0.1029 | 0.1688 | 0.12788 | 0.0367 |
| The method | 0.9687 | 24.4182 | 0.0504 | 0.0703 | 0.1407 | 0.07855 | 0.0133 |
| according to | | | | | | | |
| the present | | | | | | | |
| application | | | | | | | |

Authors of the present disclosure compared the a method according to an embodiment with various methods for generating an avatar from a single image, including those requiring additional rigging steps for animation. For clarity, the above Table 1 is divided into three sections. PIFu and PHORHUM restore the 3D mesh of a person in a pose shown in the input image. This imposes strong restrictions on the pose of a person in the input image if one wants to animate it. ARCH and ARCH++ restore the 3D mesh in canonical space, which is easier to rig and animate. StylePeople and the present disclosure are based on a parametric human model and therefore are the easiest to animate and do not suffer from rigging imperfections.

To numerically evaluate the generated avatars, reported are several metrics, namely: Multi-Scale Structural Similarity (MS-SSIM ↑), Peak Signal-to-Noise Ratio (PSNR ↑), Learned Perceptual Image Patch Similarity (LPIPS ↓). These reference-based metrics are measured in the front view avatars for the SnapshotPeople public benchmark. For the front view the method according to the present application works on par with non-rigged methods in terms of these metrics. To evaluate the quality of the back view (and thus the ability to generalize to new views), Kernel Inception Distance (KID ↓) measurements are reported. This metric allows one to evaluate generated images quality and is more suitable for small amounts of data than FID. The method according to the present application resulted in the highest KID value compared to other methods. To assess identity preservation reidentification score (ReID ↓) was measure based on FlipReID model for human re-identification. The method according to the present application resulted in the best results in person's identity preserving between front and back views. To additionally validate the quality of the textures and to measure structural similarity in cases with unaligned ground truth images Deep Image Structure and Texture Similarity (DISTS ↓) was measure. Provided in Table 1 are measurements for front view and back view. The method according to the present application produced the most naturally looking avatars from both views.

Thus, the method according to the present application realistically reconstructs the texture of clothing fabrics on the back (e.g., pleats on pants), which boosts the realism of the renders. Using the whole information from the given image allows not to copy unwanted patterns from front to back (as is commonly done by the pixel-aligned methods while recovering the texture for the back). Using sampled RGB texture as an addition to a neural texture allows to achieve photo-realistic facial details and preserve high frequency details. It had been noted that PIFu accurately reproduces the color of the avatar and restores the geometry well. However, it does not preserve high-frequency details, which is why avatars suffer from a lack of photo-realism. PHORHUM generates highly photorealistic avatars but often suffers from color shifts. Another methodological shortcoming of this approach is the absence of a human body prior. Therefore, the model can be overfitted on training dataset's human poses, which may lead to incorrect work with unseen poses. Avatars generated by ARCH contain strong color artifacts and suffer from geometry restoration errors. ARCH++ significantly improves geometry and color quality for the frontal view, but the back view still suffers from color shift and artifacts. StylePeople is based on a parametric human model and can be easily animated without the use of third-party methods or additional rigging. However, the coverage of the latent space of their model is limited, which leads to overfitting and poor generalization to unseen people, when performing inference based on a single view.

Disclosed herein is an inventive method for modeling human avatars based on neural textures that combine the RGB and the latent components. The RGB components are used to preserve the high frequency details, while the neural components add hair and clothing to the base SMPL-X mesh. Using the parametric SMPL-X model as a basis makes it easy to animate the resulting avatar. The method according to the present application restores missing texture parts using an adapted diffusion framework for inpainting such textures. The method thus is capable of creating rigged avatars, while also improving the rendering quality of the unseen body parts when compared to modern non-rigged human model reconstruction methods.

A person skilled in the art may further understand that various illustrative logical blocks (illustrative logical blocks) and steps (steps) that are listed in the embodiments of this application may be implemented by electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of the embodiments of this application.

This application further provides a non-transitory computer-readable storage medium. The computer-readable medium stores computer-executable instructions, and parameters including at least weights and biases of the trained pipeline of the encoder E-generator G network, the diffusion-based inpainting model, and the neural renderer θ, wherein upon execution of the computer-executable instructions by a computing device (e.g. the above described computing device 50) the computing device is caused to carry out a method of generating fullbody animatable avatar of a person from a single image of the person according to the first aspect of the present application or any development thereof.

All or some of the foregoing embodiments may be implemented by using software, hardware, firmware, or any combination thereof. When software is used to implement the embodiments, the embodiments may be implemented completely or partially in a form of a computer-executable instructions. When the computer instructions are loaded and executed on a computing device, the procedure or functions according to embodiments of this application are all or partially generated. The computer instructions may be stored in a computer-readable storage medium or may be transmitted from a computer-readable storage medium to another computer-readable storage medium. For example, the computer instructions may be transmitted from a website, computing device, server, or data center to another website, computing device, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computing device, or a data storage device, for example, a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid-state drive, SSD)), or the like.

It should also be noted that the order of sequence of steps of the disclosed method is not strict, i.e., some (one or more) steps may be rearranged and/or combined with each other. Throughout the materials of the present application a reference to an element in singular form does not preclude the presence of a plurality of such elements in the actual implementation of embodiments, and, vice versa, a reference to an element in plural form does not preclude the presence of only one such element in the actual implementation of embodiments. Any value of the above specified parameter values given above should not be interpreted in a limiting sense, instead it should be considered to represent a midpoint of a certain range defined as the midpoint±up to approximately 20%.

According to one or more embodiments, to make the avatars animatable, neural texture approach may be leveraged along with the SMPL-X parametric body model. An architecture for generating the neural textures is proposed, in which the texture may include both the RGB part explicitly extracted from the input image by warping and additional neural channels obtained by mapping the image to a latent vector space and decoding the result into the texture space. The texture generation may be trained in an end-to-end fashion with the rendering network. To restore the neural texture for unobserved parts of the human body a diffusion model is developed. This approach may provide for photo-realistic human avatars from single images. In the presence of multiple images, neural textures corresponding to different images may be merged while parts that are still missing may be restored by diffusion-based inpainting. At least the use of diffusion for inpainting distinguishes the present disclosure from related art including StylePeople that rely on generative adversarial framework to perform inpainting of human body textures. It has been found that the use of diffusion may alleviate problems with mode collapse and allows to obtain plausible samples from complex multi-modal distributions.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A computer-implemented method of generating fullbody animatable avatar of a person from a single image of the person, the method comprising:
obtaining an image of a person body and a parametric body model defined by pose parameters and shape parameters of the person body in the image, and by camera parameters used when capturing the image;
defining, based on the parametric body model, a texturing function including a mapping between each pixel corresponding to a part of the person body shown in the image and corresponding texture coordinates in a texture space, and corresponding texture coordinates in the texture space for a part of the person body not shown in the image;
sampling RGB texture of the person body based on the mapping and obtaining a map of sampled pixels, wherein the RGB texture includes:
for each pixel corresponding to a part of the person body shown in the image, a corresponding pixel value, and
one or more unshown texture regions corresponding to the texture coordinates for the part of the person body not shown in the image;
passing the image of the person body through a trained encoder-generator network to generate texture of the person body shown in the image;
concatenating the RGB texture, the map of sampled pixels, and the generated texture to obtain neural texture;
inpainting unshown texture regions of the neural texture by a trained diffusion-based inpainting model; and
translating a rasterized image of a fullbody avatar of the person body in a different pose by a trained neural renderer into a rendered image of the fullbody avatar of the person body in the different pose,
wherein the rasterized image is obtained based on the inpainted neural texture and the mapping included in the texturing function, in which wherein the parametric body model is modified based on target pose parameters or target camera parameters, and
wherein the target pose parameters or the target camera parameters correspond to the different pose of the fullbody avatar of the person body.

2. The method of claim 1, further comprising inpainting, in the sampled RGB texture, gaps not exceeding a predetermined threshold size based on an average of neighbouring pixels to obtain a map of inpainted pixels, wherein the concatenating the RGB texture comprises using the map of inpainted pixels to obtain the neural texture.

3. The method of claim 1, wherein the inpainting unshown texture regions of the neural texture comprises:
adding Gaussian noise to the neural texture, and
iteratively running a denoising procedure on the neural texture with the Gaussian noise, by the trained diffusion-based inpainting model, until the inpainted neural texture is shown and the Gaussian noise is not shown.

4. The method of claim 1, wherein the parametric body model is based on fixed-topology mesh driven by the pose parameters and the shape parameters.

5. The method of claim 1, wherein an encoder of the trained encoder-generator network is based on a StyleGAN2 discriminator and trained to compress an image to a feature vector, and
wherein a generator of the trained encoder-generator network is based on StyleGAN2 generator and trained to generate texture from the feature vector.

6. The method of claim 1, wherein the mapping is based on a UV unwrapping performed with a front cut of a representation of the person body in the image.

7. The method of claim 1, further comprising detecting an occluded area of the person body in the image, and excluding the occluded area during the sampling of the RGB texture.

8. The method of claim 1, wherein the trained diffusion-based inpainting model includes a Denoising Diffusion Probabilistic Model (DDPM) including denoising U-Net architecture trained to inpaint unshown texture regions of the neural texture to obtain the inpainted neural texture, wherein the denoising U-Net architecture includes BigGAN residual blocks for upsampling and downsampling, and attention layers on a number of feature hierarchy levels of the denoising U-Net architecture.

9. The method of claim 8, wherein the trained diffusion-based inpainting model further includes a Vector Quantized Generative Adversarial Network (VQGAN) autoencoder including an encoder trained to encode the neural texture into a lower dimensional latent representation of the neural texture input to the denoising U-Net architecture, and a decoder trained to decode an output of the denoising U-Net architecture to the inpainted neural texture.

10. The method of claim 1, further comprising training the encoder-generator network, the diffusion-based inpainting model, and the neural renderer, wherein the training comprises:
performing a first training stage at which the encoder-generator network and the neural renderer being based on a rendering U-Net architecture having ResNet blocks, which form a pipeline, are trained in an end-to-end manner based on multi-view image sets used as training data, the first training stage comprising:
sampling two different images from a same set of the multi-view image sets, including a first image depicting a person body in a pose having input pose parameters used as an input image, and a second image depicting the person body in a pose having different target pose parameters used as a ground truth image,
passing the first image and the target pose parameters through the pipeline being trained to render an image of an avatar of the person body in a pose having target pose parameters,
calculating, based at least on the rendered image and the ground truth image, a loss value according to one or more loss functions among a difference loss between the rendered image and the corresponding ground truth image, a learned perceptual image patch similarity (LPIPS) loss between the rendered image and the corresponding ground truth image, a nonsaturating adversarial loss based on StyleGAN2 discriminator with R₁-regularization, or a Dice loss between a predicted segmentation mask and a ground truth segmentation mask,
calculating gradients based on the loss value, and
updating parameters of the encoder-generator network and the neural renderer based on the gradients; and
based on the loss value according to the one or more of loss functions being minimized, fixing learned parameters of the encoder-generator network and the neural renderer and performing a second training stage at which the diffusion-based inpainting model comprising at least a denoising U-Net architecture is added to the pipeline and trained using conditional diffusion learning to inpaint unshown texture regions of the neural texture, the second training stage comprising:
merging incomplete neural textures of two or more images covering different view angles and sampled from a same multi-view image set of the multi-view image sets used as training data to obtain a merged neural texture used as a ground truth neural texture,
adding Gaussian noise to the merged neural texture in accordance with an unspecified step among a number of iterations at which a denoising procedure is performed by the trained diffusion-based inpainting model,
concatenating, to the merged neural texture with the added Gaussian noise, an incomplete neural texture of the incomplete neural textures for obtaining the merged neural texture,
passing the merged neural texture with the added Gaussian noise and with concatenated incomplete neural texture through the diffusion-based inpainting model predicting, for the unspecified step, a noise to be removed for obtaining the inpainted merged neural texture,
calculating, based at least on the predicted noise to be removed and the added Gaussian noise, a loss value according to the one or more of loss functions,
calculating gradients based on the loss value, and
updating parameters of the denoising U-Net architecture used for diffusion-based inpainting based on the gradients; and
based on the loss value being minimized, fine-tuning the pretrained pipeline.

11. The method of claim 10, wherein the fine-tuning comprises fixing weights and biases of the neural renderer, and propagating gradients from a differentiable neural renderer to RGB channels of the RGB texture, and
wherein the gradients are based on the loss value obtained at the first training stage.

12. The method of claim 10, wherein the first training stage further comprises:
based on the VQGAN autoencoder being included in the trained diffusion-based inpainting model, training the VQGAN autoencoder to encode neural textures into lower dimensional latent representations of the neural textures, and decode lower dimensional latent representations of the neural textures by minimizing the loss value according to the one or more loss functions used at the first training stage, and
wherein, the second training stage is performed in a latent space of the pretrained VQGAN autoencoder.

13. The method of claim 10, wherein the first training stage further comprises calculating the difference loss and the LPIPS loss for an entire image, and with a predetermined weight for an image area corresponding to a face.

14. Computing device comprising:
at least one processor; and
a memory storing processor-executable instructions, and parameters comprising weights and biases of a trained pipeline of an encoder-generator network, a diffusion-based inpainting model, and a neural renderer,
wherein the at least one processor is configured to execute the processor-executable instructions to perform a method of generating a fullbody animatable avatar of a person body from a single image of the person body,
wherein the method comprises:
obtaining an image of the person body and an estimated parametric body model defined by pose parameters, shape parameters of the person body in the image, and camera parameters used when capturing the image;
defining, based on the parametric body model, a texturing function including a mapping between each pixel corresponding to a part of the person body shown in the image and corresponding texture coordinates in a texture space, and corresponding texture coordinates in the texture space for a part of the person body not shown in the image;
sampling RGB texture of the person body based on the mapping, and obtaining a map of sampled pixels, wherein the RGB texture includes:
for each pixel corresponding to a part of the person body shown in the image, a corresponding pixel value, and
one or more unshown texture regions corresponding to the texture coordinates for the part of the person body not shown in the image;
passing the image through a trained encoder-generator network to generate texture of the person body shown in the image;
concatenating the RGB texture, the map of sampled pixels and the generated texture to obtain neural texture;
inpaint unshown texture regions of the neural texture by a trained diffusion-based inpainting model; and
translate a rasterized image of the fullbody avatar of the person body in a different pose by a trained neural renderer into a rendered image of the fullbody avatar of the person body in the different pose,
wherein the rasterized image is obtained based on the inpainted neural texture and the mapping included in the texturing function, in which the parametric body model is modified based on target pose parameters based on target camera parameters, and
wherein the target pose parameters or the target camera parameters correspond to the different pose of the fullbody avatar of the person body.

15. Computer-readable medium storing computer-executable instructions, and parameters comprising weights and biases of a trained pipeline of an encoder-generator network, a diffusion-based inpainting model, and a neural renderer, wherein by executing the computer-executable instructions, a computing device is configured to perform a method of generating fullbody animatable avatar of a person from a single image of the person, the method comprising:
obtaining an image of a person body and an estimated parametric body model defined by pose parameters and shape parameters of the person body in the image, and camera parameters used when capturing the image;
defining, based on the parametric body model, a texturing function including a mapping between each pixel corresponding to a part of the person body in the image and corresponding texture coordinates in a texture space, and corresponding texture coordinates in the texture space for a part of the person body not shown in the image;
sampling RGB texture of the person body based on the mapping and obtaining a map of sampled pixels, wherein the RGB texture comprises:
for each pixel corresponding to a part of the person body in the image, a corresponding pixel value, and
one or more unshown texture regions corresponding to the texture coordinates for the part of the person body not shown in the image;
passing the image through a trained encoder-generator network to generate texture of the person body shown in the image;
concatenating the RGB texture, the map of sampled pixels and the generated texture to obtain neural texture;
inpainting unshown texture regions of the neural texture by a trained diffusion-based inpainting model;
translating a rasterized image of the fullbody avatar of the person body in a different pose by a trained neural renderer into a rendered image of the fullbody avatar of the person body in the different pose,
wherein the rasterized image is obtained based on the inpainted neural texture and the mapping included in the texturing function, in which the parametric body model is modified based on target pose parameters or target camera parameters, and
wherein the target pose parameters or the target camera parameters correspond to the different pose of the fullbody avatar of the person.

16. The computer-readable medium of claim 15, further comprising inpainting, in the sampled RGB texture, gaps not exceeding a predetermined threshold size based on an average of neighbouring pixels to obtain a map of inpainted pixels, wherein the concatenating the RGB texture comprises using the map of inpainted pixels to obtain the neural texture.

17. The computer-readable storage media of claim 15, wherein the inpainting unshown texture regions of the neural texture comprises:
adding Gaussian noise to the neural texture, and
iteratively running a denoising procedure on the neural texture with the Gaussian noise, by the trained diffusion-based inpainting model, until the inpainted neural texture is shown and the Gaussian noise is not shown.

18. The computer-readable medium of claim 15, wherein the parametric body model is based on fixed-topology mesh driven by the pose parameters and the shape parameters.

19. The computer-readable medium of claim 15, wherein an encoder of the trained encoder-generator network is based on a StyleGAN2 discriminator and trained to compress an image to a feature vector, and
wherein a generator of the trained encoder-generator network is based on StyleGAN2 generator and trained to generate texture from the feature vector.

20. The computer-readable medium of claim 15, wherein the mapping is based on a UV unwrapping performed with a front cut of a representation of the person body in the image.
